(19) United States
(12) Patent Application Publication
(10) Pub. No.: US 2015/0199165 A1
(43) Pub. Date: Jul. 16, 2015

(54) AUTOMATIC PROXIMITY DISPLAY SWITCHING FOR A MIRACAST ENVIRONMENT

(71) Applicant: Nvidia Corporation, Santa Clara, CA (US)

(72) Inventors: Harshal Chopde, Pune (IN); Manish Tiwari, Pune (JP); Abhishek Kumar, Pune (IN); Ankit Mendiratta, Pune (IN)

(73) Assignee: Nvidia Corporation, Santa Clara, CA (US)

(21) Appl. No.: 14/156,675

(22) Filed: Jan. 16, 2014

(51) Int. Cl. G06F 3/14; H04N 21/414; G09G 5/00; H04N 21/41

(52) U.S. Cl. CPC G06F 3/1454; H04N 21/4122; H04N 21/41407; G09G 5/006; G09G 2370/16

(57) ABSTRACT

A proximity display system includes a mobile device that is enabled for Miracast sourcing and that provides a screen display. The proximity display system also includes a plurality of display units, which is enabled for Miracast sinking and is also coupled to the mobile device. Additionally, the proximity display system further includes a proximity sensing unit, which is coupled to the plurality of display units and enables a presentation of the screen display on a selected one of the plurality of display units based on a transmission signal strength received from the mobile device at the selected one. A method of operating a proximity display system is also included.

### TECHNICAL FIELD

This application is directed, in general, to an electronic system and, more specifically, to a proximity display system and a method of operating a proximity display system.

### BACKGROUND

With the ever increasing processing power of mobile devices (e.g., smartphones and computer tablets), complex entertainment solutions are becoming more and more mobile. However, small display sizes remain a basic drawback of using these devices. The Miracast standard addresses these issues by providing a new class of applications where a user is able to stream frames being rendered on the smaller display of a mobile device to a larger display for a better display experience. Currently, these mobile devices are restricted from moving from an area close to the larger display without having to reinitialize setup conditions with the larger display. Improvements in this area would prove beneficial to the art.

### SUMMARY

Embodiments of the present disclosure provide a proximity display system and a method of operating a proximity display system.

In one embodiment, the proximity display system includes a mobile device that is enabled for Miracast sourcing and that provides a screen display. The proximity display system also includes a plurality of display units, which is enabled for Miracast sinking and is also coupled to the mobile device. Additionally, the proximity display system further includes a proximity sensing unit, which is coupled to the plurality of display units and enables a presentation of the screen display on a selected one of the plurality of display units based on a transmission signal strength received from the mobile device at the selected one.

In another aspect, the method of operating a proximity display system includes providing a mobile device enabled for Miracast sourcing that employs a screen display and providing a plurality of display units enabled for Miracast sinking. The method of operating a proximity display system also includes determining a presentation of the screen display on a selected one of the plurality of display units based on a transmission signal strength received from the mobile device at the selected one.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

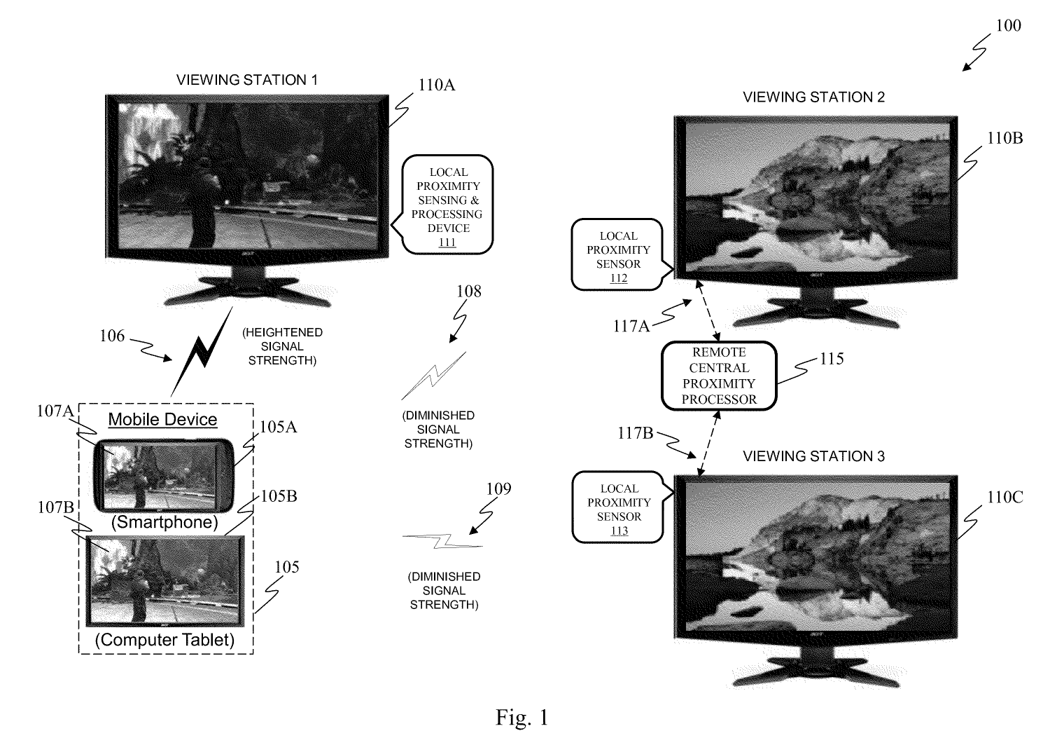

FIG. 1 illustrates a pictorial diagram of an embodiment of a proximity display system for Miracast use, constructed according to principles of the present disclosure;

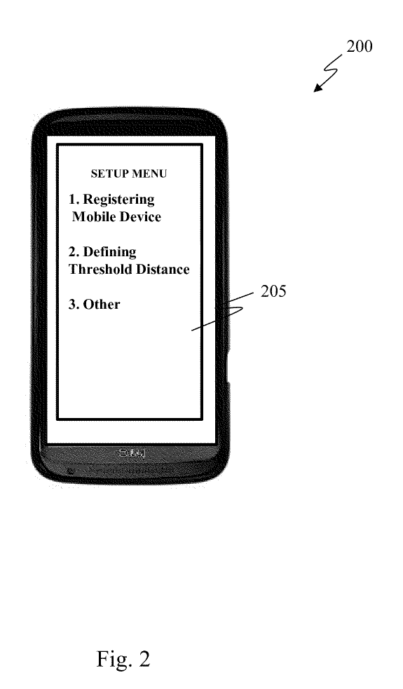

FIG. 2 illustrates a pictorial diagram of an embodiment of a smartphone mobile device as may be employed in the proximity display system of FIG. 1; and

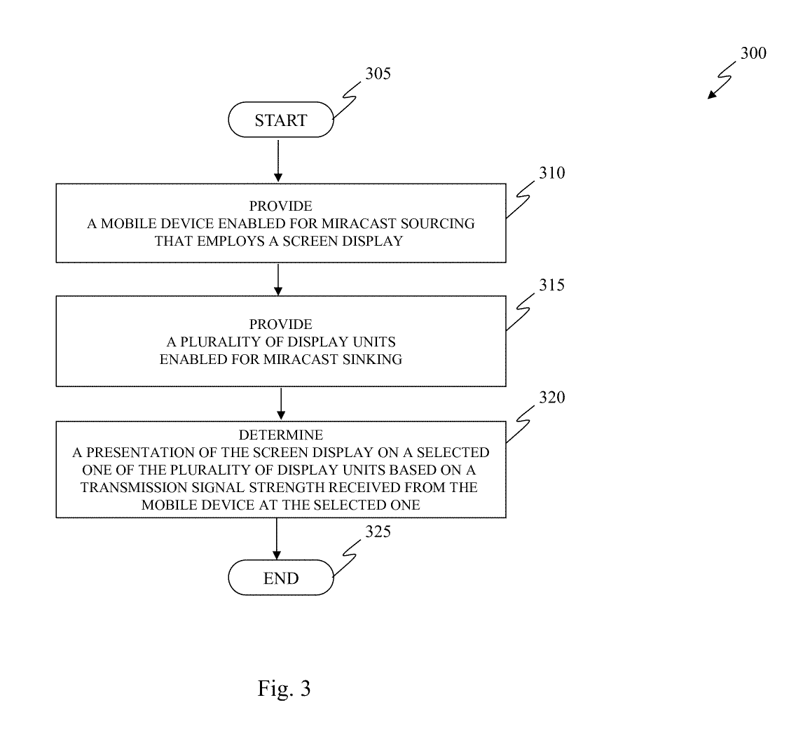

FIG. 3 illustrates a flow diagram of an embodiment of a method of operating a proximity display system, generally designated 300, carried out according to the principles of the present disclosure.

### DETAILED DESCRIPTION

FIG. 1 illustrates a pictorial diagram of an embodiment of a proximity display system for Miracast use, generally designated 100, constructed according to principles of the present disclosure. The proximity display system 100 includes a mobile device 105 and a plurality of Miracast-enabled display units 110A, 110B, 110C.

The mobile device 105 may be a smartphone 105A or a computer tablet 105B, for example. The plurality of Miracast-enabled display units 110A, 110B, 110C are first, second and third television viewing stations. In the illustrated embodiment, a proximity sensing unit includes a dedicated local proximity sensing and processing device 111 and separate local proximity sensors 112, 113 that communicate with a shared remote central proximity processor 115 via respective first and second communications channels 117A, 117B. The dedicated local proximity sensing and processing device 111 is intended to service only one Miracast-enabled display unit. Alternately, the shared remote central proximity processor 115 may provide processing for a plurality of Miracast-enabled display units having only separate local proximity sensors.

Generally, dedicated local proximity sensing and processing devices or separate local proximity sensors service a single Miracast-enabled display unit, where they may be internally or externally positioned. External sensors or devices may be connected to a corresponding Miracast-enabled display unit employing appropriately available standard connections or wirelessly to onboard Miracast sourcing or sinking units, as required. Additionally, a remote central proximity processor may be located or positioned near one of the Miracast-enabled display units thereby allowing it to be connected locally as a processing device for that local unit, while still accepting separate local proximity sensor input from other Miracast-enabled display units for processing.

In the illustrated example, the first television viewing station 110A employing the dedicated local proximity sensing and processing device 111 is in closest proximity to the mobile device 105 thereby providing a heightened signal strength transmission 106 to the first television viewing station 110A. This allows viewing of a mobile device display image 107A or 107B on the first television viewing station 110A, as shown.

Additionally, the second and third television viewing stations 110B, 110C employing the separate local proximity sensors 112, 113, the shared remote central proximity processor 115 and the communications channels 117A, 117B are in farthest proximity to the mobile device 105 thereby respectively providing diminished signal transmissions 108, 109 from the mobile device 105 to the second and third television viewing stations 110B, 110C. These diminished signal transmissions 108, 109 are too weak to allow viewing of the mobile device display image 107A or 107B. In this embodiment, the first and second communications channels 117A, 117B may be wireless, wired or combinations of both.

The dedicated local sensing and processing device 111 provides and processes transmission signal strength indications for the first television viewing stations 110A. Correspondingly, the shared remote central proximity processor 115 processes transmission signal strength indications from the separate local proximity sensors 112, 113 in the second and third television viewing stations 110B, 110C. These correspond to transmission signal strengths provided from the mobile device 105 through the first, second and third signal strength transmissions 106, 108, 109, respectively. Additionally, control signals are returned that direct switching to the view of the mobile device display image 107A or 107B for the plurality of Miracast-enabled display units 110A, 110B, 110C, as warranted.

For example, as the mobile device 105 moves between the first and second television viewing stations 110A, 110B, a point is reached where the mobile device display image 107A or 107B on the first television viewing station 110A is transferred to the second television viewing station 110B. At this or some point farther along the path, the mobile device display image 107A or 107B disappears from the first television viewing station 110A, where it may return to previous television or other programming.

This process continues as the mobile device 105 continues on to a closest proximity for the third television viewing station 110C. In each of these cases, the originally heightened signal strength transmission 106 becomes a heightened signal strength transmission 108 and finally a heightened signal strength transmission 109. When not in closest proximity, the other two signal strength transmissions become diminished.

FIG. 2 illustrates a pictorial diagram of an embodiment of a smartphone mobile device, generally designated 200, as may be employed in the proximity display system 100 of FIG. 1. The smartphone mobile device 200 is an example of mobile devices and includes a screen display showing a Setup Menu 205 that may be employed to provide initial information for the smartphone mobile device 200 and a plurality of Miracast-enabled display units such as those shown and discussed with respect to FIG. 1.

Here, the screen display may employ touch screen capabilities or be used to further direct selections of the Setup Menu 205 in another fashion. The setup menu 205 includes providing for initially registering the smartphone mobile device 200 with the plurality of Miracast-enabled display units wherein this smartphone registration is maintained until its specific cancellation (i.e., enduringly registered). Additionally, the Setup Menu 205 provides for establishing a threshold distance (based on transmission signal strength) between the smartphone mobile device 200 and selected ones of the plurality of Miracast-enabled display units.

This threshold distance establishes a maximum distance between the mobile device 200 and the selected ones of the plurality of Miracast-enabled display units to initiate having a current display on the smartphone mobile device 200 be shown on each of the selected ones of the plurality of Miracast-enabled display units. As noted, the threshold distance corresponds to a received transmission signal strength at the plurality of Miracast-enabled display units.

This threshold distance may also be different between the smartphone mobile device 200 and each of the selected ones of the plurality of Miracast-enabled display units. These different threshold distances may be required due to physical constraints affecting the plurality of Miracast-enabled display units, for example. The Setup Menu 205 may also be employed as a check list to direct the setup actions of registering or providing a threshold distance at each location of the plurality of Miracast-enabled display units. Alternately, each threshold distance may be determined interactively between the smartphone mobile device 200 and each of the plurality of Miracast-enabled display units.

FIG. 3 illustrates a flow diagram of an embodiment of a method of operating a proximity display system, generally designated 300, carried out according to the principles of the present disclosure. The method 300 starts in a step 305. Then, a mobile device enabled for Miracast sourcing that employs a screen display is provided in a step 310, and a plurality of display units enabled for Miracast sinking is provided in a step 315. A presentation of the screen display on a selected one of the plurality of display units is determined based on a transmission signal strength received from the mobile device at the selected one, in a step 320.

In one embodiment, providing the plurality of display units includes providing at least one television viewing station. In another embodiment, determining the presentation of the screen display includes employing local proximity sensing and processing for at least one of the plurality of display units. In yet another embodiment, determining the presentation of the screen display includes employing remote central proximity processing that communicates with local proximity sensing for at least one of the plurality of display units.

In still another embodiment, the transmission signal strength is compared to a threshold signal strength for determining the selected one of the plurality of display units. In one case, the threshold signal strength is independently selectable for each of the plurality of display units. In another case, the threshold signal strength is determined from the mobile device. In yet another case, the threshold signal strength is determined interactively between the mobile device and each of the plurality of display units.

In a further embodiment, the mobile device is enduringly registered with each of the plurality of display units. Correspondingly, registering the mobile device is accomplished from the mobile device. The method 300 ends in a step 325.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A proximity display system, comprising:
a mobile device, enabled for Miracast sourcing, that provides a screen display;
a plurality of display units, enabled for Miracast sinking, that is coupled to the mobile device; and
a proximity sensing unit, coupled to the plurality of display units, that enables a presentation of the screen display on a selected one of the plurality of display units based on a transmission signal strength received from the mobile device at the selected one.

2. The system as recited in claim 1 wherein at least one television viewing station is included in the plurality of display units.

3. The system as recited in claim 1 wherein the proximity sensing unit includes employing a local proximity sensing and processing device for at least one of the plurality of display units.

4. The system as recited in claim 1 wherein the proximity sensing unit includes employing a remote central proximity processor that communicates with a local proximity sensor for at least one of the plurality of display units.

5. The system as recited in claim 1 wherein the transmission signal strength is compared to a threshold signal strength contained in the proximity sensing unit for determination of the selected one of the plurality of display units.

6. The system as recited in claim 5 wherein the threshold signal strength is independently selectable for each of the plurality of display units.

7. The system as recited in claim 5 wherein the threshold signal strength is determined from the mobile device.

8. The system as recited in claim 5 wherein the threshold signal strength is determined interactively between the mobile device and each of the plurality display units.

9. The system as recited in claim 1 wherein the mobile device is enduringly registered with each of the plurality of Miracast-enabled display units during an initial setup routine.

10. The system as recited in claim 9 wherein registering the mobile device is accomplished from the mobile device.

11. A method of operating a proximity display system, comprising:
providing a mobile device enabled for Miracast sourcing that employs a screen display;
providing a plurality of display units enabled for Miracast sinking; and
determining a presentation of the screen display on a selected one of the plurality of display units based on a transmission signal strength received from the mobile device at the selected one.

12. The method as recited in claim 11 wherein providing the plurality of display units includes providing at least one television viewing station.

13. The method as recited in claim 11 wherein determining the presentation of the screen display includes employing local proximity sensing and processing for at least one of the plurality of display units.

14. The method as recited in claim 11 wherein determining the presentation of the screen display includes employing remote central proximity processing that communicates with local proximity sensing for at least one of the plurality of display units.

15. The method as recited in claim 11 wherein the transmission signal strength is compared to a threshold signal strength for determining the selected one of the plurality of display units.

16. The method as recited in claim 15 wherein the threshold signal strength is independently selectable for each of the plurality of display units.

17. The method as recited in claim 15 wherein the threshold signal strength is determined from the mobile device.

18. The method as recited in claim 15 wherein the threshold signal strength is determined interactively between the mobile device and each of the plurality of display units.

19. The method as recited in claim 11 wherein the mobile device is enduringly registered with each of the plurality of display units.

20. The method as recited in claim 19 wherein registering the mobile device is accomplished from the mobile device.
